(19) United States
(12) Patent Application Publication
(10) Pub. No.: US 2016/0280526 A1
(43) Pub. Date: Sep. 29, 2016

(54) VENDING MACHINE

(71) Applicant: Jayme Patrick O'Laughlin, Weston, MA (US)

(72) Inventor: Jayme Patrick O'Laughlin, Weston, MA (US)

(21) Appl. No.: 14/789,734

(22) Filed: Jul. 1, 2015

Related U.S. Application Data
(60) Provisional application No. 62/137,088, filed on Mar. 23, 2015.

(51) Int. Cl. B67D 1/00; B67D 1/12

(52) U.S. Cl. CPC B67D 1/0007; B67D 1/1295

(57) ABSTRACT

A method and apparatus for vending nutritional beverage materials. A vending machine includes a housing having a vending area arranged to receive a container, a liquid supply arranged to provide a liquid from a liquid source to the container, a nutritional supplement supply arranged to provide the powdered nutritional supplement to the container, and a controller operatively coupled to the liquid supply and the nutritional supplement supply to control dispensing of the liquid and the nutritional supplement into the container. When the liquid and nutritional supplement are dispensed into the container, at least a portion of the nutritional supplement rests unmixed and on top of the liquid.

### CROSS-REFERENCE TO RELATED APPLICATIONS

This Application claims priority under 35 U.S.C. §119(e) to U.S. Provisional Application Ser. No. 62/137,088, entitled “GG SINGLE-USE PROTEIN SHAKERS VENDING MACHINE” filed on Mar. 23, 2015, which is herein incorporated by reference in its entirety.

### FIELD

The disclosed embodiments are generally directed to vending machines, and more particularly to vending machines that dispense nutritional supplements.

### BACKGROUND

Vending machines have become available to dispense nutritional supplements (e.g., protein supplements) to individuals, and typically in the form of a ready-to-drink beverage. For example, some vending machines dispense a liquid that has been mixed prior to being loaded into the machines, while other vending machines mix a liquid or powdered protein supplement and water inside the machine and then dispense the mixed beverage to the consumer.

### SUMMARY

According to one embodiment, a vending machine is disclosed. The vending machine includes a housing having a vending area arranged to receive a container, a liquid supply arranged to provide a liquid from a liquid source to the container, a nutritional supplement supply arranged to provide a powdered nutritional supplement to the container, and a controller operatively coupled to the liquid supply and the nutritional supplement supply to control dispensing of the liquid and the nutritional supplement into the container. The controller is configured to dispense the liquid and nutritional supplement into the container so that, when dispensation completes, at least a portion of the nutritional supplement rests unmixed with, and on top of, the liquid.

According to another embodiment, a method of vending nutritional beverage ingredients to a container in a vending area of a vending machine is disclosed. The method includes supplying a liquid from a liquid source to the container via a liquid supply, supplying the nutritional supplement to the container via a nutritional supplement supply, at least a portion of nutritional supplement resting unmixed and on top of the liquid, and dispensing the container with the nutritional beverage ingredients to a user of the vending machine.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front view of a vending machine according to one aspect;

FIG. 2 is an interior view of the vending machine of FIG. 1;

FIG. 3 is an enlarged view of a portion of a nutritional supplement supply, according to one embodiment;

FIG. 4 is an enlarged view of a container dispenser, according to one embodiment;

FIG. 5 is an enlarged view of a liquid supply, according to one embodiment;

FIG. 6 is a perspective view of container with a protein powder dispensed on top water;

FIG. 7 is a perspective view of a container with protein powder dispensed on top of water, with a lid attached thereto;

FIG. 8 is a perspective view of an empty container with an attached lid, according to one aspect;

FIG. 9 is an example of a computing system; and

FIG. 10 is a flow chart of an illustrative vending sequence in accordance with one aspect.

### DETAILED DESCRIPTION

Nutritional supplements, such as protein powders, are conventionally consumed by individuals who exercise, such as individuals who consume protein supplements to help with muscle recovery and development after workouts. Traditionally, protein supplements are consumed in the form of a protein shake, which is hand-made by the individual by mixing the protein supplements (usually in powdered form) with water. Often, these individuals seek to consume the protein shake shortly after working out (e.g., within about a half an hour of working out), as the benefits of protein supplements are greatest if they are consumed shortly after completing a workout. These individuals also seek to prepare a fresh protein shake during this post-workout time since the shake may spoil and/or lose taste if it is prepared before and stored during the workout. Preparing a fresh protein shake at the gym (e.g., by mixing the water and protein powder in front of others) is also a symbol to others that the individual is an avid exerciser.

As can be appreciated, hand-mixing a protein shake for consumption shortly after a workout means that the individual must either transport the protein powder and a bottle suitable for mixing the protein shake with him/her to the workout location (e.g., to a gym), or must rush home after his/her workout is over to make and consume the protein shake within the relatively brief post-workout time window. This is not only inconvenient, it is time consuming. As a result, vending machines have recently become available to vend single-serve, ready-to-drink protein shakes. These vending machines dispense protein shakes which are either mixed prior to being loaded into the machine (e.g., they dispense individually sealed bottles of the pre-mixed shake or they dispense a single serving of the pre-mixed shake into a disposable cup) or mixed within the machine itself (e.g., by internal components designed to mix a liquid or powder protein supplement and water, and then dispensed the mixed protein shake).

The Assignee has appreciated that protein shakes that are mixed prior to being loaded into the vending machine are typically laden with preservatives and/or other ingredients with little to no nutritional benefits, such as flavorings and fillers, to help keep them from spoiling while being stored in the vending machine and/or to enhance the taste of the shake. The Assignee also has appreciated that many fitness-conscious individuals who take supplements after working out may not wish to consume such preservatives or unnecessary ingredients. Moreover, these additives may delay the absorption of protein by the body since they may be digested first and thus delay and/or hinder muscle development and/or recovery. The Assignee has further appreciated that while vending machines with internal mixing components may be capable of dispensing protein shakes which are devoid of such preservatives and other ingredients, the mixing components (e.g., conduits, valves, mixing chambers, etc.) are very difficult to keep clean and rid of harmful bacteria (which could be introduced into a shake dispensed to a customer), due to the physical composition of a protein shake. Equipment used to mix protein shakes also may develop a foul smell, which may be unappealing to consumers.

The Assignee has further appreciated that protein shakes that are hand-made or that are dispensed by the vending machine (e.g., either mixed prior to being loaded into the machine or mixed by the machine itself) typically contain more than a single serving of protein (e.g., more than can be absorbed by the body). For example, an individual making his/her own shake may incorrectly believe that consuming extra protein will help develop muscles and/or recover faster. As another example, pre-made shakes (e.g., shakes that are mixed prior to loading in the machine) are often advertised as being a meal-replacement, and thus typically contains more than a single-serving of protein. In these instances, the extra protein ingested by the consumer is removed from the body as waste, and this may be taxing on an individual's kidneys.

In contrast to these conventional approaches, some embodiments of the present invention provide a vending machine configured to dispense a single serving of beverage ingredients (e.g., protein powder and water) in a manner which consumers may readily appreciate as being fresh, wholesome and nutritionally beneficial ingredients that are ready to be mixed with the water and consumed. For example, in some embodiments, a vending machine is equipped to dispense protein powder and water into a single-serve container so that the protein powder rests at least partially on top of the water, so that it can be visually inspected and tasted by the consumer prior to mixing with the water to produce a fresh protein shake for consumption.

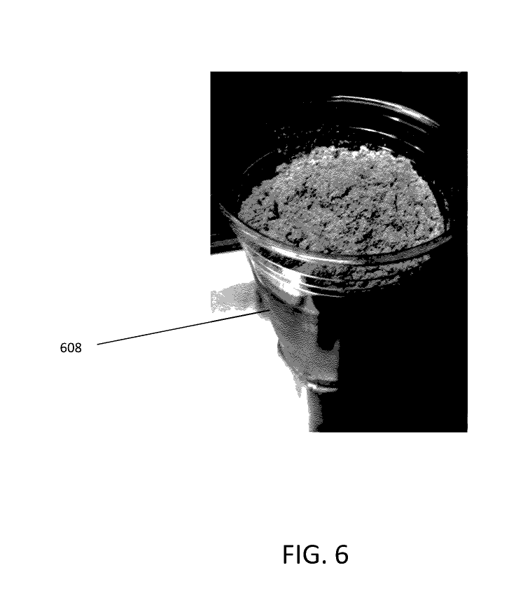

According to one aspect, the vending machine may have a liquid supply for supplying water to the container, a nutritional supplement supply for supplying protein powder to the container, and a controller operatively coupled to the liquid supply and the nutritional supplement supply for controlling the dispensation of water and protein powder such that the protein powder rests at least partially on top of and at least partially unmixed from the water (see, e.g., FIG. 6). As will be appreciated, in these embodiments, the protein powder and the water are not mixed internally by the machine (e.g., there are no mixing chambers within the machine). Instead, the protein powder and water are kept separate inside the vending machine and only contact one another when they water and protein powder are dispensed into the container.

In some embodiments, the vending machine dispenses a single-serving of protein. In some embodiments, the vending machine is arranged to dispense the beverage ingredients into a disposable container which may be provided by the consumer or dispensed by the vending machine. In some embodiments, the disposable container is sized to accommodate a single-serving of protein to the consumer (e.g., the disposable container may hold enough water to mix with the single serving of protein to produce a protein shake when mixed).

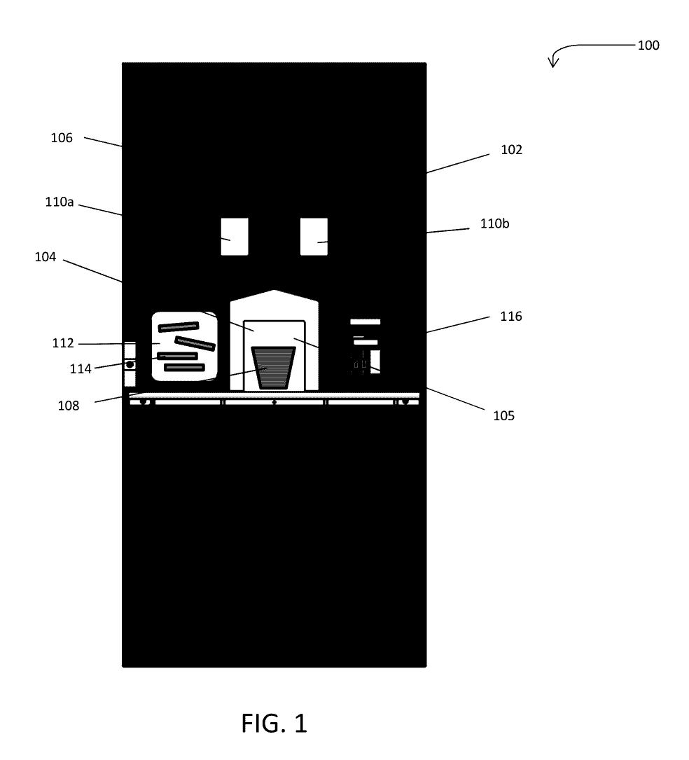

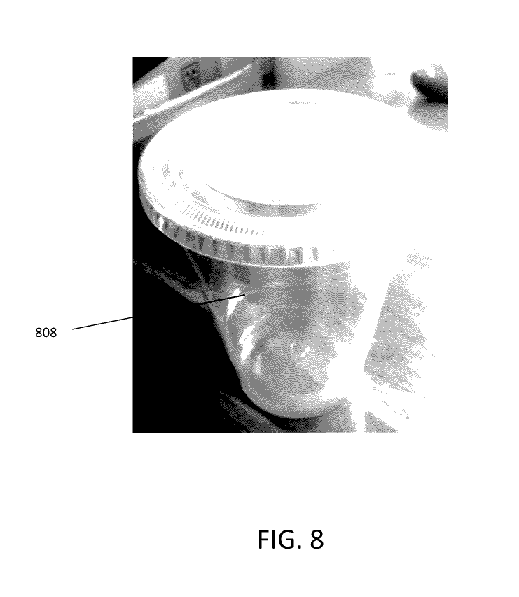

Turning now to the figures, FIG. 1 shows a vending machine 100 according to one aspect. As is shown, the vending machine 100 includes a housing 102 with a vending area 104 for receiving a container 108, such as a cup 808 shown in FIG. 8, into which a liquid, such as water, and nutritional supplement, such as protein powder, may be dispensed. In some embodiments, the vending area 104 includes an chamber in a front 106 of the housing 102. The vending area 104 may include a cover, such as a window 105, that protects the container in the machine during dispensation of the water and protein powder, yet allows the user to continue to view the container while he/she waits. The window may be hingedly attached to the housing in some embodiments, although other suitable attachment mechanisms may be used (e.g., a sliding attachment between the window and housing). As will be appreciated, the window may be opened to insert and/or remove the container 108 from the machine 100. The vending area also may have other suitable covers for protecting the container in the machine while the liquid and nutritional supplement are being dispensed.

As shown in FIG. 1, the vending machine also may include one or more vending buttons 110a, 110b that correspond to different types of nutritional supplements that may be dispensed from the machine 100. For example, the vending buttons 110a, 110b may corresponds to a chocolate flavored protein powder and a vanilla flavored protein powder, respectively. As will be appreciated, although the vending machine is shown with two vending buttons, the machine may have more or less buttons in other embodiments. For example, the vending machine may have only one vending button in some embodiments, while in other embodiments, the vending machine may have three or more vending buttons. Each vending button may be associated with any suitable type of nutritional supplement.

The vending machine 100 also may include a lid dispenser 112 for holding one or more lids 114, which a user may take from the lid dispenser 112 and affix to a top of the container (e.g., prior to shaking the container 108 to mix the water and protein powder). In some embodiments, the lid dispenser includes a chamber in the front 106 of the housing into which the lids 114 are inserted. In other embodiments, the lid dispenser 112 includes an enclosure that is attached to the front of the housing for storing the lids 114. In such embodiments, the lid dispenser 112 may be permanently attached to the housing, although it also may be removably attachable to the housing.

In some embodiments, the vending machine includes a payment terminal 116, which a user may use to pay for a beverage. As will be appreciated, the payment terminal 116 may allow a user to pay with cash, coins, or with a credit card. As will further be appreciated, in embodiments in which a user may pay with a credit card, the machine 100 may have a wireless or wired connection for transmitting credit card information to a remote server (not shown).

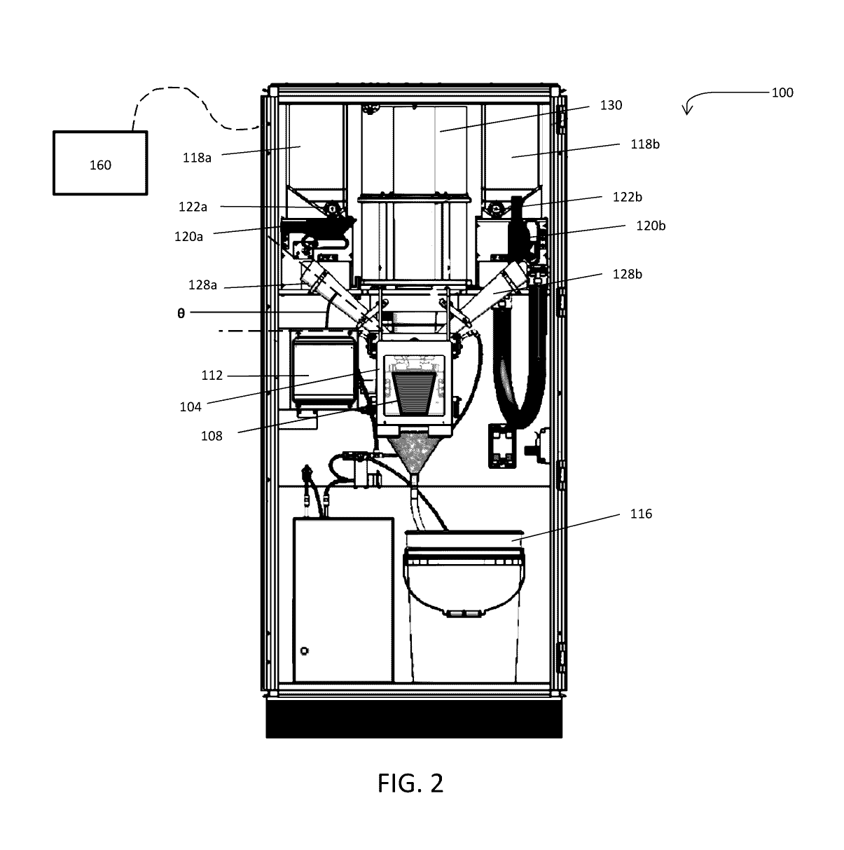

FIG. 2 shows an interior view of the vending machine 100. As is shown, the vending machine 100 includes one or more nutritional supplement canisters 118a, 118b, into which fresh protein powder may be stored for dispensing into the container 108. As will be appreciated, the number of nutritional supplement canisters 118a, 118b may correspond to the number of vending buttons 110a, 110b on the front of the vending machine 100.

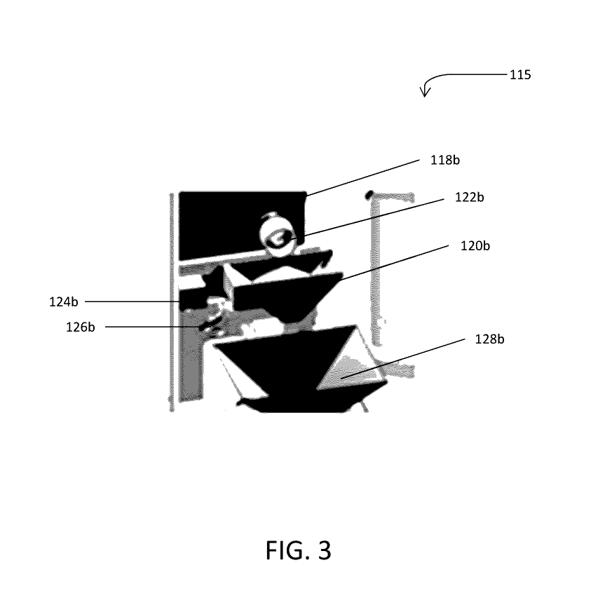

In some embodiments, the canisters 118, 118b are auger buckets, although any other suitable canister(s) may be used. As shown in FIG. 2 and FIG. 3, an enlarged view of a portion of the nutritional supplement supply 115, the vending machine also includes a nutritional supplement weighing bin 120a, 120b, a weighing balance counterweight 124a, 124b, and a weighing balance motor arm 126a, 126b for measuring and dispensing a single serving of the protein powder. In some embodiments, the single serving of the protein powder is between about between about 20 grams and 35 grams of protein powder, or between about 30 grams and 35 grams of protein powder, or about 33 grams of protein powder. In such embodiments, the weight of the single serving of protein powder corresponds to a single serving of protein, which, in some embodiments is about 25 grams of protein. As will be appreciated, the weight of the single serving of protein powder (e.g., the weight that corresponds to the single serving of protein) may vary depending on the density of the protein powder and the serving size of protein. In FIG. 2, where there are two weighing bins 120a, 120b, a first weighing bin 120a is shown in a closed position, in which the weighing bin is ready to measure protein powder, and a second weighing bin 120b shown in a released position, after the protein powder has been dispensed.

In some embodiments, the single serving of protein is about 25 grams of protein.

In some embodiments, the protein powder in one of the canister 118a, 118b is fed to its corresponding weighing bin 120a, 120b, respectively, via a respective outlet 122a, 122b. Once the protein powder in the weighing bin 120a, 120b reaches a weight corresponding to the desired serving size (e.g., equal to the weighing counterbalance), the auger stops and the weighing balance motor arm 126a, 126b releases the weighing bin 120a, 120b, thus allowing the weighing bin 120a, 120b to pivot and pour the protein powder into its respective chute 128a, 128b.

As will be appreciated, in other embodiments, instead of dispensing the protein powder into the chute after a target weight has been met, the protein powder also may be delivered after a target period of time has elapsed. That is, the auger may stop and the balance motor arm may release the weighing bin to pour the protein powder into the chute after a period of time needed to supply the desired serving size of protein powder has elapsed.

As shown in FIG. 2, the protein powder travels from the chute 128a, 128b into the container 108 in the vending area. Although the chutes are shown with a pitch of about 40° (see the angle labeled θ in FIG. 2), the chutes may have any other suitable pitch(es). For example, one or more of the chutes may have a pitch between about 35° and 45°. In some embodiments, the chutes are made of or coated with an aluminum material, which may facilitate passing of the protein into the container. The chutes also may be made of our coated with a lubricated coated composite material, such as an ultra-high molecular weight (“UHMW”) plastic sheet.

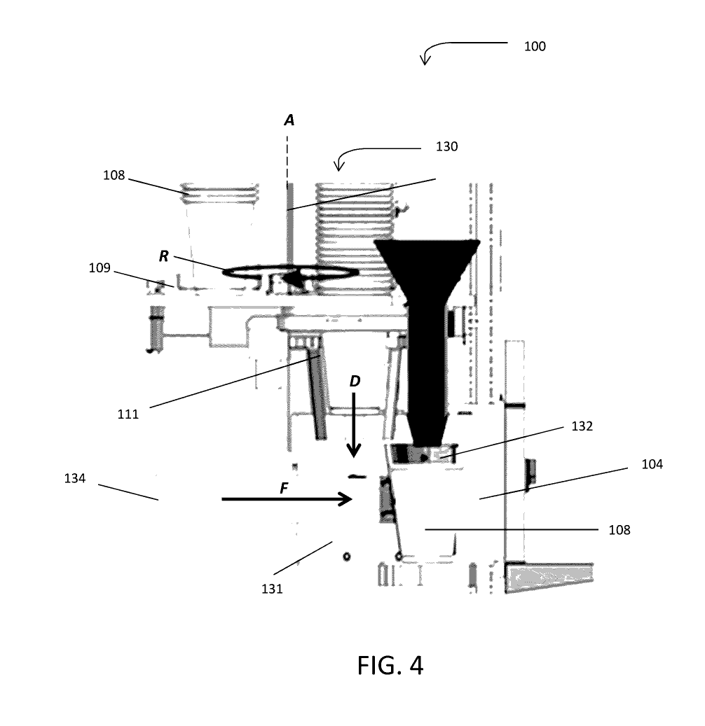

In some embodiments, the machine 100 includes a container dispenser 130, which, in some embodiments, is located inside the housing 102. As will be appreciated, the container dispenser 130 may dispense a container 108 to the vending area 104. In one example, as shown in FIG. 4, the container dispenser 130 includes a turret 109 onto which one or more containers 108 may be stacked. During use of the vending machine, the turret 109 is rotated about a vertical axis A (see the arrow labeled R) until the container reaches an opening 111 through which the container is dropped (see the arrow labeled D). As is shown, the container is dropped into a chamber 131 which, in some embodiments, includes a three-sided metal frame with hinged doors 132 in the front. As will be appreciated, the chamber may be sized to fit the container (e.g., having a length and width that correspond to the diameter of a rim of the container), such that the container does not fall over when dropped into the chamber. An arm 134 may push the chamber forward (see the arrow labeled F), and the hinged doors 132 may open to move moved the container into the vending area 104.

As will be appreciated, other suitable mechanisms for dispensing a cup into the vending may be used. Additionally, although a mechanical container dispenser 130 is shown as being located inside the housing, in other embodiments, the container dispenser 130 may include an enclosure attached to the front or side of the housing for holding containers. In such an embodiment, a user may remove a container 108 from the chamber and insert it into the vending area prior to dispensing the beverage ingredients (e.g., the water and protein powder). In such an embodiment, the chamber may be permanently attached to the front of the housing or it may be removably attachable.

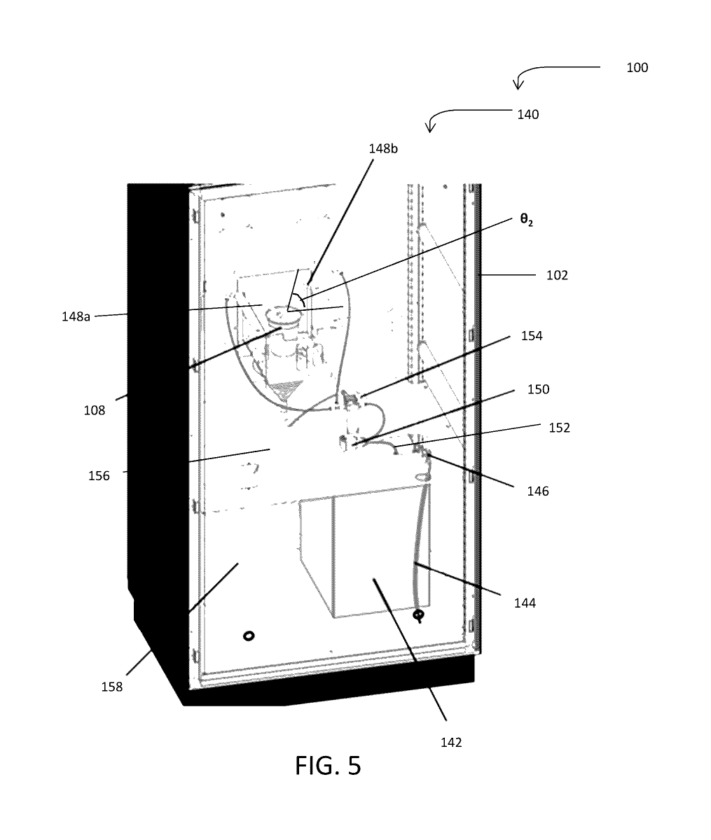

As shown in FIG. 2 and FIG. 5, an enlarged view of the liquid supply 140, liquid such as water, juice and/or any other suitable liquid, is fed to the vending machine 100 and to a liquid conditioner 142 (e.g., a chiller) where the liquid is cooled prior to dispensing. In the example shown in FIG. 5, water is fed to the liquid conditioner 142 via a conduit 144 that is connected to the water supply of a building. In such an embodiment, a valve, such as shut off valve 146, is turned on and off to supply water to the conditioner 142. The water supplied to the conditioner may be passed through a filter before entering the conditioner 142 in some embodiments. As will be appreciated, although the water supply is shown in this as being the building's water supply, in other embodiments, the water supply may include a water reservoir inside the chiller that is fillable by the owner of the vending machine.

The liquid in the chiller is dispensed into the container via one or more nozzles 148a, 148b. In some embodiments, liquid is dispensed via the nozzles at custom angles to allow the powder to rest on top of and at least partially unmixed from the water. In some embodiments, the nozzles 148a, 148b are positioned at an angle (labeled θ₂ in FIG. 5) of about 70 degrees, although other suitable angles may be used. In some embodiments, the nozzles 148a, 148b are angled towards one another such that the streams of liquid (e.g., water) exiting the nozzles 148a, 149b hit one another when entering the container. As shown, the nozzles may be positioned such that water enters at opposite sides of the container.

As shown in FIG. 5, a flow meter 150 measures the flow of the water in the conduit 152 exiting the liquid conditioner 142, and a fill valve 154 is opened and closed to dispense a single serving of water to the nozzles 148a, 148b. In some embodiments, the single serving of water may be between about 8 ounces and 12 ounces, or about 10 ounces of water. As is shown, the fill valve 154 may be a three-way valve. In some embodiments, the fill valve is also connected to a conduit 156 that transfers incidental waste liquid to a collection bucket 158.

In some embodiments, a controller 160 (FIG. 2) controls operation of the vending machine and, in particular, the operation of the liquid supply and the nutritional supplement supply. In some embodiments, after the user submits his payment and selects the type of nutritional supplement he wishes to purchase, the controller activates the liquid supply to dispense a single serving of water into the container (e.g., from the liquid conditioner, through the conduits, and out of the one or more nozzles). In such embodiments, the controller may then activate the nutritional supplement supply (e.g., after activating the liquid supply), to begin dispense the protein powder into the container after the liquid has been fully dispensed. In other embodiments, the nutritional supplement supply is activated after the liquid supply to begin dispensing the protein powder when two-thirds of the liquid has been dispensed into the container. In still another embodiment, the nutritional supplement supply may be activated at the same time as the liquid supply, such that the water and protein powder are dispensed into the container at the same time. As will be appreciated, when the nutritional supplement supply is activated, the protein powder is fed from the nutritional supplement canister to the weighing bin, and thereafter to the respective chute. In each of these embodiments, after the protein powder and water have been dispensed, the protein powder rests at least partially unmixed and at least partially on top of the water, as is shown in FIG. 6. In some embodiments, the total time for dispensing the water and protein powder is between about 30 and 45 second, or about 40 seconds. In other embodiments, the total time for dispensing is about 25 seconds. In such embodiments, the water may be dispensed into the container for about 15 seconds, and the protein powder may be dispensed into the container for about 10 seconds.

Although the vending machine has been shown and described as having a single, predetermined, serving size of the water and protein powder, in other embodiments, the vending machine may allow the user to select not only the type of nutritional supplement that he wishes to consume, but also the serving size. That is, the vending machine may allow a user to buy a beverage with half of the serving size of the protein supplement or more than one serving size of the protein supplement.

Although embodiments have been shown and described with a vending machine dispensing a protein powder into the container, it will be appreciated that other nutritional supplements also may be dispensed from the vending machine. For example, amino acids, vitamins, minerals, herbs, energy drinks, any combination thereof, or other suitable nutritional supplement(s) may be dispensed into the container.

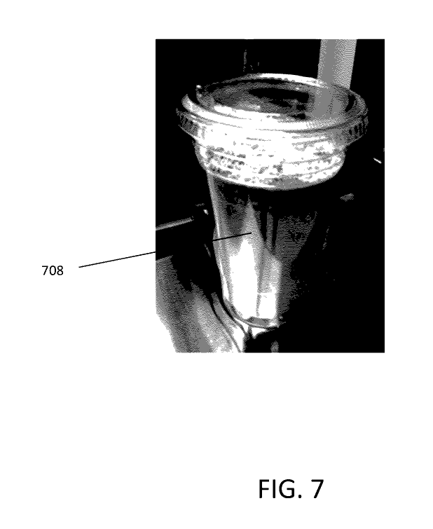

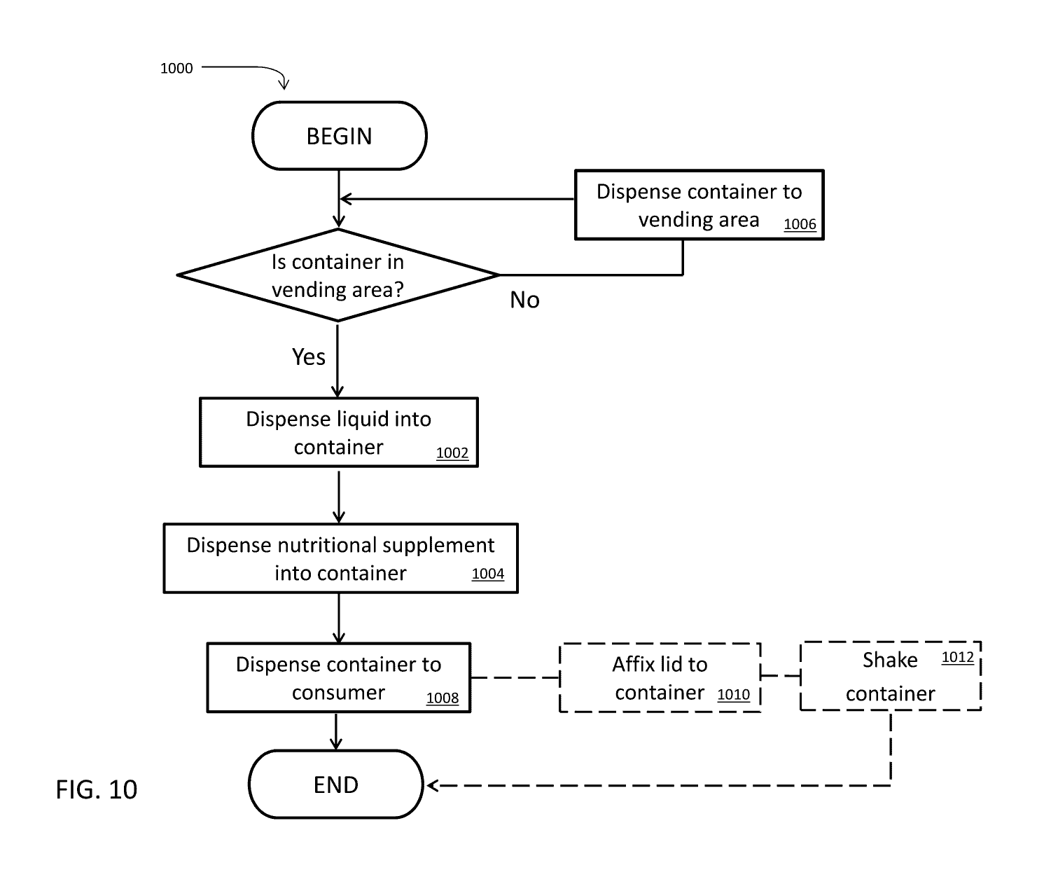

According to another aspect, a method of vending a nutritional supplement is disposed. As shown in FIG. 10, in some embodiments, the method 1000 includes dispensing a liquid into the container 1002 via a liquid supply and dispensing a powdered nutritional supplement into the container 1004 via the nutritional supplement supply. The method may include dispensing a container to a vending area 1006 before dispensing the liquid and nutritional supplement. In some embodiments, a container dispenser in the vending machine dispenses the container to the vending area. In other embodiments, a user may place a container in the vending area. The method further includes dispensing the container to the user 1008 with the powdered nutritional supplement at least partially on top of and at least partially unmixed from the liquid. In some embodiments, the method further includes, by a user, taking a lid from a lid dispenser and affixing the lid 1010 to a top of the container. An example of a container with a nutritional supplement at least partially on top of and unmixed from the liquid and with an attached lid is illustrated in FIG. 7. The user may then shake the container 1012 at least two or three times to mix the powdered nutritional supplement into the liquid.

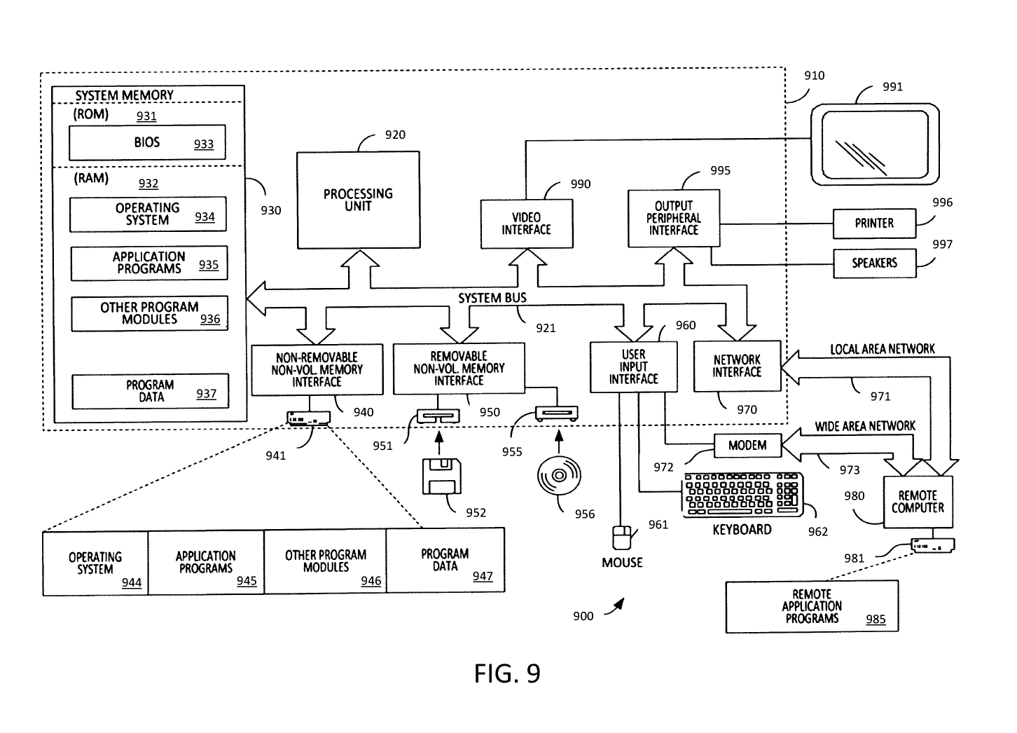

It should be appreciated from the foregoing that some embodiments of the invention may employ a computing system. For example, in some embodiments, controller 160 may comprise a computing system. FIG. 9 illustrates one example of a suitable computing system 900 which may be used to implement aspects of the invention. The computing system 900 is only one example of a suitable computing, and is not intended to suggest any limitation as to the scope of use or functionality of the invention. Neither should the computing system 900 be interpreted as having any dependency or requirement relating to any one or combination of components illustrated in FIG. 9. In this respect, the invention is operational with numerous other general purpose or special purpose computing systems or configurations. Examples of well-known computing systems that may be suitable for use with the invention include, but are not limited to, application-specific integrated circuits, server computers, multiprocessor systems, microprocessor-based systems, set top boxes, programmable consumer electronics, network PCs, minicomputers, distributed computing environments that include any of the above systems or devices, and the like.

The computing system may execute computer-executable instructions, such as one or more program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 9 depicts a general purpose computing device in the form of a computer 910. Components of computer 910 may, for example, include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 910. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through an non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 536, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 560 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through a output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., to modify a term or element does not by itself connote any priority, precedence, or order of term or element over another, or the temporal order in which acts of a method are performed, but are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A vending machine comprising:
a housing having a vending area arranged to receive a container;
a liquid supply arranged to provide a liquid from a liquid source to the container;
a nutritional supplement supply arranged to provide a powdered nutritional supplement to the container; and
a controller operatively coupled to the liquid supply and the nutritional supplement supply to control dispensing of the liquid and the nutritional supplement into the container;
wherein the controller is configured to dispense the liquid and nutritional supplement into the container so that, when dispensation completes, at least a portion of the nutritional supplement rests unmixed with, and on top of, the liquid.

2. The vending machine of claim 1, wherein the controller is configured to dispense the liquid into the container prior to dispensing the nutritional supplement.

3. The vending machine of claim 1, wherein the controller is configured to dispense at least a portion of the nutritional supplement into the container while the liquid is being dispensed.

4. The vending machine of claim 1, further comprising a container dispenser disposed in the housing, wherein the controller is operatively coupled to the container dispenser to control dispensing of a container to the vending area.

5. The vending machine of claim 3, wherein the controller is arranged to dispense the container to the vending area prior to dispensing the liquid and nutritional supplement.

6. The vending machine of claim 3, wherein the container is disposable.

7. The vending machine of claim 1, further comprising a lid dispenser.

8. The vending machine of claim 1, wherein the liquid supply is disposed within the housing.

9. The vending machine of claim 8, wherein the liquid supply includes a liquid conditioner arranged to chill the liquid prior to dispensing the liquid into the container.

10. The vending machine of claim 9, further comprising a liquid source, wherein the liquid source is arranged to supply the liquid to the liquid conditioner.

11. The vending machine of claim 1, wherein the controller is arranged to provide a single serving of liquid to the container.

12. The vending machine of claim 11, wherein the single serving of liquid is between about 8 ounces and about 12 ounces of liquid.

13. The vending machine of claim 1, wherein the nutritional supplement supply comprises a first nutritional supplement canister arranged to store a first nutritional supplement, the first nutritional supplement canister being disposed in the housing.

14. The vending machine of claim 1, wherein the controller is arranged to dispense a serving of the first nutritional supplement into the container.

15. The vending machine of claim 14, wherein the serving of the first nutritional supplement is between about 22 grams and about 35 grams.

16. The vending machine of claim 13, wherein the nutritional supplement supply further comprises a second nutritional supplement canister arranged to store a second nutritional supplement, the second nutritional supplement canister being disposed in the housing.

17. The vending machine of claim 16, wherein the controller is arranged to dispense a single serving of one of the first and second nutritional supplements to the container.

18. The vending machine of claim 1, wherein the nutritional supplement is protein powder.

19. A method of vending nutritional beverage ingredients to a container in a vending area of a vending machine, the method comprising:
supplying a liquid from a liquid source to the container via a liquid supply;
supplying the nutritional supplement to the container via a nutritional supplement supply, at least a portion of nutritional supplement resting unmixed and on top of the liquid; and
dispensing the container with the nutritional beverage ingredients to a user of the vending machine.

20. The method of claim 19, further comprising supplying a container to the vending area prior to supplying the liquid and nutritional supplement.

21. The method of claim 19, wherein supplying the liquid comprises supplying a single serving of between about 8 ounces and 12 ounces of liquid to the container.

22. The method of claim 19, wherein supplying the nutritional supplement comprises supplying a single serving of between about 22 grams and 35 grams of the nutritional supplement to the container.

23. The method claim 19, wherein supplying a liquid from a liquid source to the container via a liquid supply comprises chilling the liquid via a liquid conditioner;

24. The method claim 19, wherein supplying the nutritional supplement comprises supplying a single serving of at least one of a first nutritional supplement stored in a first nutritional supplement canister and a second nutritional supplement stored in a second nutritional supplement canister.

25. The method of claim 19, wherein the method further comprises affixing a lid to a top of the container.

26. The method of claims 25, further comprising shaking the container to mix the nutritional beverage ingredients.

27. The method of claim 19, wherein supplying the nutritional supplement to the container comprises supplying the nutritional supplement to the container after supplying all of the liquid to the container.

28. The method of claim 19, wherein supplying the nutritional supplement to the container comprises supplying at least a portion of the nutritional supplement while supplying the liquid to the container.
